(19) United States
(12) Patent Application Publication
(10) Pub. No.: US 2025/0192827 A1
(43) Pub. Date: Jun. 12, 2025

(54) NETWORK NODE AND METHOD IN A WIRELESS COMMUNICATIONS NETWORK

(71) Applicant: Telefonaktiebolaget LM Ericsson (publ), Stockholm (SE)

(72) Inventors: Alexey SHAPIN, Luleå (SE); Hideshi MURAI, Zushi (JP); Leefke GROSJEAN, Täby (SE); Peter DE BRUIN, Gammelstad (SE); Swarup KUMAR MOHALIK, Bangalore (IN)

(21) Appl. No.: 18/844,231

(22) PCT Filed: Mar. 8, 2022
(86) PCT No.: PCT/SE2022/050227

§ 371 Date: Sep. 5, 2024

(51) Int. Cl. H04B 7/04; H04L 5/00; H04W 24/02

(52) U.S. Cl. CPC H04B 7/04013; H04L 5/0094; H04W 24/02

(57) ABSTRACT

A method performed by a network node for handling beam-based communication between a terminal and a radio network node in a wireless communications network. The wireless communication network includes a Reconfigurable Intelligent Surface, RIS, for reflecting radio signals between the terminal and the radio network node. The RIS is controlled by the network node which predicts for each terminal, one or more first communication parameters to be used for the beam-based communication between the terminal and the radio network node. The network node configures each terminal, radio network node and RIS based on the predicted parameters. In response to a predicted change the network node estimates for each terminal, one or more second communication parameters to be used for the beam-based communication. Based on an evaluation of the predicted change, the network node updates the configuration of each terminal, radio network node and RIS according to the second communication parameters.

### TECHNICAL FIELD

Embodiments herein relate to a network node and a method therein. Furthermore, a computer program and a computer readable storage medium are also provided herein. In particular, embodiments herein relate to handling beam-based communication in a wireless communications network.

### BACKGROUND

In a typical wireless communication network, terminals, also known as wireless communication devices, mobile stations, stations (STA), wireless devices and/or User Equipments (UE), communicate via a Wide Area Network or a Local Area Network such as a Wi-Fi network, e.g. assisted by licensed access, or a cellular network comprising a Radio Access Network (RAN) part and e.g. a Core Network (CN) part. The RAN covers a geographical area which is divided into service areas or cell areas, which may also be referred to as a beam or a beam group, with each service area or cell area being served by a radio network node such as a radio access node e.g., a Wi-Fi access point or a radio base station (RBS), which in some networks may also be denoted, for example, a NodeB, eNodeB (eNB), or gNB as denoted in Fifth Generation (5G) telecommunications, where RBS may have multiple antennas and each antenna has a capability to create beams. A service area or cell area is a geographical area where radio coverage is provided by the radio network node. The radio network node communicates over an air interface operating on radio frequencies with the wireless device within range of the radio network node.

3GPP is the standardization body for specify the standards for the cellular system evolution, e.g., including 3G, 4G, 5G and the future evolutions. Specifications for the Evolved Packet System (EPS), also called a Fourth Generation (4G) network, have been completed within the 3rd Generation Partnership Project (3GPP). As a continued network evolution, the new releases of 3GPP specifies a 5G network also referred to as 5G New Radio (NR).

Frequency bands for 5G NR are being separated into two different frequency ranges, Frequency Range 1 (FR1) and Frequency Range 2 (FR2). FR1 comprises sub-6 GHz frequency bands. Some of these bands are bands traditionally used by legacy standards but have been extended to cover potential new spectrum offerings from 410 MHz to 7125 MHz. FR2 comprises frequency bands from 24.25 GHz to 52.6 GHz. Bands in this millimeter wave range have shorter range but higher available bandwidth than bands in the FR1.

Multi-antenna techniques may significantly increase the data rates and reliability of a wireless communication system. For a wireless connection between a single user, such as a terminal, and a radio network node, the performance is in particular improved if both the transmitter and the receiver are equipped with multiple antennas, which results in a Multiple-Input Multiple-Output (MIMO) communication channel. This may be referred to as Single-User (SU)-MIMO. In the scenario where MIMO techniques is used for the wireless connection between multiple terminals and the radio network node, MIMO enables the terminals to communicate with the radio network node simultaneously using the same time-frequency resources by spatially separating the terminals, which increases further the cell capacity. This may be referred to as Multi-User (MU)-MIMO. Note that MU-MIMO may benefit when each terminal only has one antenna. Such systems and/or related techniques are commonly referred to as MIMO.

In the application of present and upcoming generations of networks in industry, ultra-high speed/capacity, ultra-reliable communication should be provided in a single system at a reasonable cost for Augmented Reality (AR) and/or Virtual Reality (VR) applications, communication with industrial robots, and communication between industrial robots.

### SUMMARY

As a part of developing embodiments herein a problem was first identified and will be discussed herein.

In order to achieve ultra-high speed and large capacity communication, a high frequency, e.g. a millimeter Wave (mmW) or higher, may be required to ensure a wide bandwidth. However, it is difficult to achieve sufficient performance with a small number of radio network nodes and/or antennas because they may be blocked by obstacles. Furthermore, ultra-reliable communication is not possible at high frequencies due to potential blockage by the obstacles.

An object of embodiments herein is to improve the performance of a wireless communications network.

According to an aspect of embodiments herein, the object is achieved by a method performed by a network node for handling beam-based communication between a terminal and a radio network node in a wireless communications network. The wireless communications network comprises a Reflective Intelligent Surface (RIS) for reflecting radio signals between the terminal and the radio network node. The RIS is controlled by the network node. The network node predicts for each terminal, one or more first communication parameters to be used for a beam-based communication between the terminal and the radio network node. The beam-based communication satisfies one or more criteria. The network node configures each terminal, radio network node and RIS based on the predicted one or more first communication parameters. In response to a predicted change in wireless communications network, the network node estimates for each terminal, one or more second communication parameters to be used for the beam-based communication between the terminal and the radio network node. Based on an evaluation of the predicted change, taking one or more present parameters into account, the network node updates the configuration of each terminal, radio network node and RIS according to the one or more second communication parameters in order to handle the beam-based communication.

According to another aspect of embodiments herein, the object is achieved by a network node configured to handle beam-based communication between a terminal and a radio network node in a wireless communications network. The wireless communications network is adapted to comprise a Reflective Intelligent Surface, RIS, for reflecting radio signals between the terminal and the radio network node. The RIS is adapted to be controlled by the network node. The network node is further configured to:
Predict for each terminal, one or more first communication parameters adapted to be used for a beam-based communication between the terminal and the radio network node, which beam-based communication is adapted to satisfies one or more criteria,
configure each terminal, radio network node and RIS based on the one or more predicted first communication parameters,
in response to a predicted change in wireless communications network, estimate for each terminal, one or more second communication parameters adapted to be used for the beam-based communication between the terminal and the radio network node, and
based on an evaluation, taking one or more present parameters into account, update the configuration of each terminal, radio network node and RIS according to the one or more second communication parameters in order to handle the beam-based communication.

It is furthermore provided herein a computer program comprising instructions, which, when executed on at least one processor, cause the at least one processor to carry out the method above, as performed by the network node. It is additionally provided herein a computer-readable storage medium, having stored thereon a computer program comprising instructions which, when executed on at least one processor, cause the at least one processor to carry out the method according to the method above, as performed by the network node.

Since the network node predicts the one or more first communication parameters to be used for the beam-based communication, it is possible for the network node to configure each terminal, radio network node and RIS with said one or more first communication parameters. Furthermore, since the network node estimates the one or more second communication parameters in response to a predicted change in the wireless communications network, it is further possible for the network node to update the configuration of each terminal, radio network node and RIS according to the one or more second communication parameters based on an evaluation of the predicted change. This achieves an efficient handling of beam-based communications between terminals and radio network nodes, which in turn results in an improved performance of the wireless communications network.

### BRIEF DESCRIPTION OF THE DRAWINGS

Examples of embodiments herein are described in more detail with reference to attached drawings in which:

FIG. 1 is a schematic block diagram illustrating embodiments of a wireless communications network.

FIG. 2 is a schematic block diagram illustrating embodiments of a wireless communications network.

FIG. 3 is a flowchart depicting embodiments of a method in a network node.

FIG. 4 is a schematic diagram illustrating a divided bandwidth according embodiments herein.

FIG. 5 is a schematic block diagram illustrating embodiments herein.

FIGS. 6a-b are schematic block diagrams illustrating embodiments of a network node.

FIG. 7 schematically illustrates a telecommunication network connected via an intermediate network to a host computer.

FIG. 8 is a generalized block diagram of a host computer communicating via a base station with a user equipment over a partially wireless connection.

FIGS. 9-12 are flowcharts illustrating methods implemented in a communication system including a host computer, a base station and a user equipment.

### DETAILED DESCRIPTION

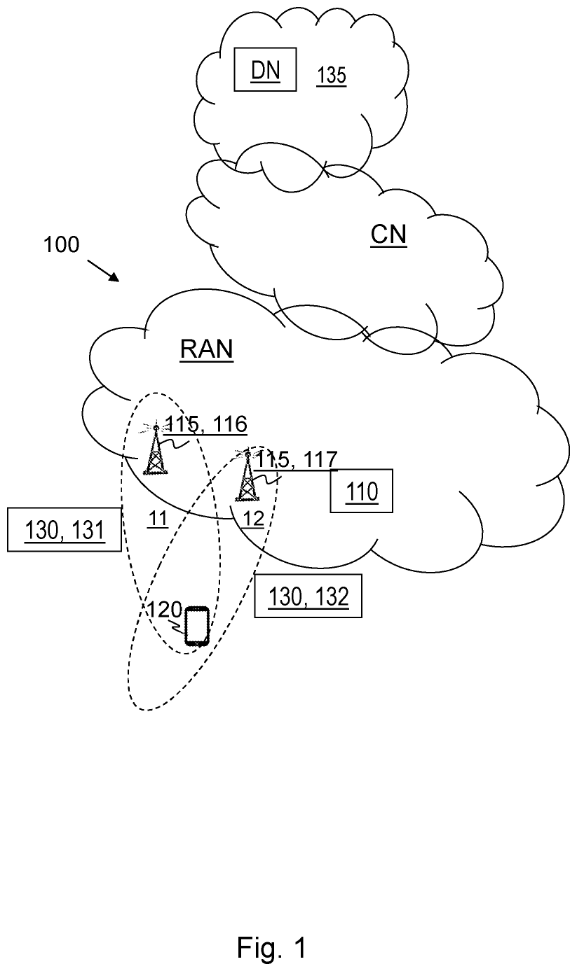

FIG. 1 is a schematic overview depicting a wireless communications network 100 wherein embodiments herein may be implemented. The wireless communications network 100 comprises one or more RANs and one or more CNs. The wireless communications network 100 may use a number of different technologies, such as Wi-Fi, Long Term Evolution (LTE), LTE-Advanced, 5G, NR, Wideband Code Division Multiple Access (WCDMA), Global System for Mobile communications/enhanced Data rate for GSM Evolution (GSM/EDGE), Worldwide Interoperability for Microwave Access (WiMax), or Ultra Mobile Broadband (UMB), just to mention a few possible implementations. Embodiments herein relate to recent technology trends that are of particular interest in a 5G context, however, embodiments are also applicable in further development of the existing wireless communication systems such as e.g. WCDMA and LTE.

A number of network nodes operate in the wireless communications network 100 such as e.g., a network node 110. Further a number of radio network nodes such as e.g. a first radio network node 116 and a second radio network node 117 also referred to as the radio network node 115. The radio network node may be connected to one or more antennas. Each antenna may have the capability to create beams, such as beams to be used for beam-based communications. The radio network nodes 115 may be associated to the network node 110. The radio network nodes 115, and in some embodiments the network node 110, provide radio coverage in a number of coverage areas in a cell, e.g. to a terminal 120. such as a coverage area 11 provided by the first radio network node 115 and a coverage area 12 provided by the second radio network node 115. The network node 110 may control the radio network nodes 115. The network node 110 may be a radio network node, e.g. the first radio network node 115 or a stand-alone server.

The network node 110, and the radio network nodes 115, 114 may each be any of a NG-RAN node, a transmission and reception point e.g. a base station, a radio access network node such as a Wireless Local Area Network (WLAN) access point or an Access Point Station (AP STA), an access controller, a base station, e.g. a radio base station such as a NodeB, an evolved Node B (eNB, eNode B), a gNB, a base transceiver station, a radio remote unit, an Access Point Base Station, a base station router, a transmission arrangement of a radio base station, a stand-alone access point or any other network unit capable of communicating with a terminal within the service area served by the network node 110 depending e.g. on the first radio access technology and terminology used. The network node 110 may be referred to as a serving radio network node and communicates with the terminal 120 with Downlink (DL) transmissions to the terminal 120 and Uplink (UL) transmissions from the terminal 120. The network node may further communicate with one or more RIS 130, which in some embodiments are controlled by the network node 110.

In the wireless communications network 100, one or more wireless devices operate, such as e.g. the terminal 120. The terminals 120 may also referred to as a device, a robot, an IoT device, a mobile station, a non-access point (non-AP) STA, a STA, a user equipment and/or a wireless terminals, communicate via one or more Access Networks (AN), e.g. RAN, to one or more core networks (CN). It should be understood by the skilled in the art that “wireless device” is a non-limiting term which means any terminal, wireless communication terminal, user equipment, Machine Type Communication (MTC) device, Device to Device (D2D) terminal, or node e.g. smart phone, laptop, mobile phone, sensor, relay, mobile tablets or even a small base station communicating within a cell.

In the wireless communications network 100, one or more RIS 130 may operate, such as e.g. a first RIS 131 and a second RIS 132, also referred to the RIS 130. The RIS 130 may be associated to and/or controlled by the network node 110. The RIS 130 may be configured to reflect radio signals, such as e.g. radio beams, also referred to as beams, between the terminal 120 and the radio network node 115, e.g. an antenna of the radio network node 115, by controlling one or more reflective elements comprised in the RIS 130. The RIS 130 may further be configured to stop reflecting radio signals, and/or change the angle of reflection. In other words, the RIS 130 may be controlled to change the reflection status of one or more reflective elements and/or changes the angle of reflection. The reflection status of a reflective element may mean whether a beam is reflected or not when hitting the reflective element, i.e. the network node 110 may control the reflection and/or transparency of the one or more reflective elements of the RIS 130.

Methods herein may be performed by the network node 110. As an alternative, a Distributed Node (DN) and functionality, e.g. comprised in a cloud 135 as shown in FIG. 1, may be used for performing or partly performing the methods herein.

A number of embodiments will now be described, some of which may be seen as alternatives, while some may be used in combination.

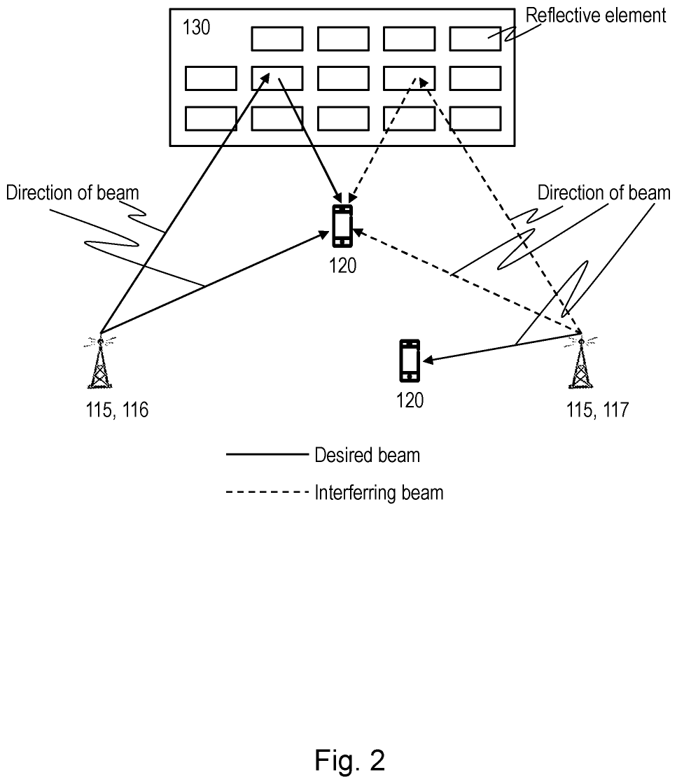

FIG. 2 shows a schematic overview of a wireless communications network according to an example scenario wherein embodiments herein may be applied. Beam-based communication using narrow beams may use high frequencies, such as milli-meter wave radio waves. Two radio network nodes 115, the first radio network node 116 and the second radio network node 117, transmit beams, e.g. narrow beams, for beam-based communication. The RIS 130 may control the reflection or transparency, e.g. a reflection coefficient related to amplitude and phase, of the one or more reflective elements and the direction, such as the angle, of reflection when a beam is reflected. In this example all reflective elements of the RIS 130 are configured to reflect the beams. The RIS may further control the beam width of the reflected beam, e.g. a radio signal or radio reflected wave. To a terminal, such as e.g. the terminal 120, a reflected beam is handled as being a part of the antenna beam, i.e. an unreflected beam. Due to the high frequency of milli-meter wave beams, diffraction may not be expected, and beams may be blocked by objects in the communication path. By using the RIS 130, narrow beams used for the beam-based communication, may be reflected and thus establish a communication path for the beam-based communication, even when there is no direct line-of-sight between the terminal 120 and the radio network node 115. The network node 110 controls the radio network nodes 115 and the RIS 130. Thus, the network node 110 may configure the RIS 130 in such a way that the interfering beam transmitted from the second radio network node 117 is not interfering with the desired signal transmitted from the first radio network node 116.

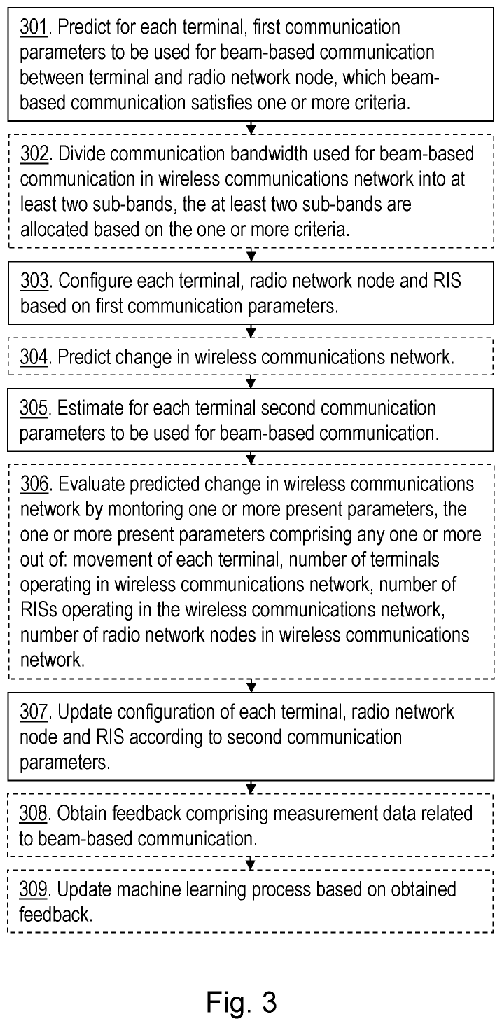

FIG. 3 shows example embodiments of a method performed by the network node 110 for handling beam-based communication between the terminal 120 and the radio network node 115 in the wireless communications network 100. The wireless communications network 100 comprises the RIS 130 for reflecting radio signals between the terminal 120 and the radio network node 115. The RIS 130 and the radio network node 115 are controlled by the network node 110. Beam-based communications when used herein mean that antennas, e.g. massive antennas, create and transmit narrow beams in certain direction and use the beams to communicate with terminals such as the terminals 120. For each direction, or terminal, such as terminal 120, there may be a preferred beam and/or combination of beams. The radio network node 115 may be connected to one or more antennas for transmitting and/or receiving the beams, such as narrow beams, in the beam-based communication.

The method comprises the following actions, which actions may be taken in any suitable order. Optional actions are referred to as dashed boxes in FIG. 3.

Action 301. The network node 110 predicts for each terminal 120, one or more first communication parameters. The one or more first communication parameters are to be used for the beam-based communication between the terminal 120 and the radio network node 115. The beam-based communication satisfies one or more criteria. The one or more first communication parameters may be related to a communication path for the beam-based communication. A communication path when used herein may mean the communication path between the terminal 120 and the radio network node 115, e.g. the communication path between the terminal 120 and an antenna connected to the radio network node 115. The communication path may comprise that a beam is reflected on a reflective element of the RIS 130. Alternatively, the communication path may comprise a direct path between the radio network node 115, such as e.g. an antenna connected to the radio network node 115, and the terminal 120, where the beam is not reflected on a reflective element of the RIS 130. Communication parameters when used herein may mean e.g. a beam the terminal may use to transmit and/or receive data and or signalling messages, the radio network node 115 handling the beam, the antenna out of the or more antenna connected to the radio network node 115 associated to the beam, the direction of the beam, the reflection status of a reflective element of the RIS 130, the angle of reflection of a reflective element of the RIS 130. Reflection status of a reflective element may mean e.g. whether or not a radio signal is reflected when hitting the surface of the panel.

In some embodiments, the network node 110 predicts the one or more first communication parameters based on a machine learning (ML) process. The network node 110 may know the location of each terminal operating tin the wireless communications network 100. Therefore, the network node 110 may predict the one or more first communication parameters for the terminal 120 based on the location of the terminal 120. The network node 110 may also be aware of the location of each RIS 130 and radio network node 115 in the wireless communications network. Thus, the network node 110 may further predict the one or more first communication parameters based on e.g. the location, capabilities, and/or configuration of the radio nodes 115 and the RIS 130. In some embodiments, the one or more criteria comprises any one or more out of:
A criterium related to high data rate communications, e.g. wherein the beam-based communication guarantees data transmission rates that are above a first threshold,
a criterium related to high capacity communications, e.g. wherein the transmission capacity of the beam-based communication is above a second threshold, such as the supported data transmission throughout and/or the supported number of connected terminals 120 is above the second threshold, wherein the second threshold may comprise more than one threshold.
a criterium related to high reliability communications, e.g. wherein the probability of packet loss for the beam-based communication below a third threshold, and
a criterium related to low latency communications e.g. wherein the latency and/or latency variation or jitter of the beam-based communication is below a fourth threshold.

High data rate communications may mean e.g. communications that require high data rate for service provided in the wireless communications network, such as e.g. video streaming, gaming, infotainment or remote computing.

High capacity communications may mean e.g. that there is a high number of terminals, such as the terminal 120, connected and/or demanding communication resources at the same time. The aggregated communications of the terminals 120 demands a high capacity of simultaneous data transmissions and/or connected terminals 120 from the wireless communications network 100.

High reliability communications may mean e.g. communications and services that require high reliability for data transmissions. E.g. factory automation, cooperative robot, public safety, haptics and/or remote medical procedures.

High and/or ultra low latency communications may mean e.g. communications that require very low latency and/or response times. E.g. factory automation, cooperative robot, public safety, haptics and/or remote medical procedures. High and/or ultra-high communications may e.g. also be referred to as Ultra-Reliable Low Latency Communications (URLLC).

The first, the second, the third and the fourth threshold may respectively depends on the requirement of the service.

The one or more first communication parameters may comprise any one or more out of: One or more first parameters related to a first beam to be used for communication between the terminal 120 and the radio network node 115, one or more first parameters related to the RIS 130, e.g. the first RIS 131, for reflecting radio signals related to the first beam, and one or more first parameters related to the radio network node 115, e.g. the first radio network node 116, associated to the first beam. The one or more first parameters related to the first beam may indicate a first beam for UL transmissions, e.g. a first UL beam and/or a first beam for DL transmissions, e.g. a first DL beam. Further, the one or more first parameters related to the first beam may comprise parameters related to the direction of the first beam and/or transmission power of the first beam. The one or more first parameters related to the RIS 130 may comprise parameters related to the angle of reflection of a reflective element, the reflection status of a reflective element and/or beam width of the reflected beam, e.g. a radio signal or radio wave, of the RIS 130. The reflection status of a reflective element may mean whether a beam is reflected or not when hitting the reflective element, i.e. the network node 110 may control the reflection and/or transparency of the reflective elements of the RIS 130. The one or more first parameters related to the radio network node 115 may comprise parameters related to the direction of the first beam, the antenna out of the one or more antennas connected to the radio network node 115 associated to the first beam and/or transmission power of the first beam.

In some embodiments the one or more first communication parameters further comprises any one or more out of: one or more first parameters related to an additional first beam, e.g. a different first beam or a third beam, to be used for communication between the terminal 120 and the radio network node 115, which additional first beam has a communication path that is different from the first beam, one or more first parameters related to the RIS 130, e.g. the first RIS 131 or the second RIS 132, for reflecting radio signals related to the additional first beam, and one or more first parameters related to the radio network node 115, e.g. the first radio network node 116 or the second radio network node 117, associated to the additional first beam. The additional first beam may be a different beam than the first beam and may e.g. be referred to as the third beam or the different first beam.

The additional first beam and the first beam may be associated to the same radio network node 115, e.g. the first radio network node 116. When associated to the same radio network node 115, the additional first beam and the first beam may be associated to the same antenna or different antennas out of the one or more antennas connected to the radio network node 115. Alternatively, the additional first beam and the first beam may be associated to different radio network nodes. E.g. the first beam may be associated to the first radio network node 116 and the additional first beam may be associated to the second radio network node 117. In other words, the first beam and the additional first beam may be associated to the same or different radio network nodes. The communication path of the additional first beam may be different than the communication path of the first beam. The RIS 130 for reflecting the additional first beam and the first beam may be the same RIS 130, e.g. the first RIS 131, or the additional first beam and the first beam may be reflected by different RISs. E.g. the first beam may be reflected by the first RIS 131 and the additional first beam may be reflected by the second RIS 132. Alternatively, the additional first beam and first beam may be reflected by different reflective elements associated to the same RIS 130, e.g. the RIS 131. The one or more first parameters related to the additional first beam may indicate an additional first beam for UL transmissions, e.g. an additional first UL beam and/or an additional first beam for DL transmissions, e.g. an additional first DL beam. Further, the one or more first parameters related to the additional first beam may comprise parameters related to the direction of the additional first beam and/or transmission power of the additional first beam. The one or more first parameters related to the RIS 130 may comprise parameters related to the angle of reflection of the reflective element, the reflection status of the reflective element and/or beam width of the reflected beam, e.g. a radio signal or radio wave. The one or more first parameters related to the network node 115 may comprise parameters related to the direction of the additional first beam, the antenna out of the one or more antennas connected to the radio network node 115 associated to the additional first beam and/or transmission power of the additional first beam.

Action 302. In some embodiments the network node 110 divides a communication bandwidth used for the beam-based communication in the wireless communications network into at least two sub-bands. The at least two sub-bands are allocated based on the one or more criteria. This may mean that a first sub-band of the bandwidth is allocated to beam-based communication related to a first criterium, e.g. the criterium related to the high data rate communications, while a second sub-band is allocated to beam-based communication related to a second criterium, e.g. the criterium related to the high reliability communications. Other combinations of sub-bands and criteria are possible, e.g. a sub-band of the bandwidth may be allocated to beam-based communication related to more than one criteria. The bandwidth may be divided in more than two sub-bands. In this way, the network node 110 is enabled to efficiently handle beam-based communications, where different criteria are satisfied for different terminals 120.

Action 303. The network node 110 configures each terminal 120, radio network node 115 and RIS 130 based on the predicted one or more first communication parameters. In other words, the network node 110 provides, such as sends or transmits, the one or more first communication parameters or indication of the first communications parameters to each terminal 120, radio network node 115 and RIS 130. This enables each terminal 120, radio network node 115 and RIS 130 to apply said configurations for the beam-based communication. Configuring the radio network node 115 may comprise configuring the one or more antennas connected to the radio network node 115 according to the predicted one or more configuration parameters.

Action 304. Changes, such as events, may happen in the wireless communications network 100. Another terminal may be added to, such as connect to, removed from, such as disconnected from, and/or the terminal 120 may change its location in the wireless communications network 100. Further, one or more radio network nodes 115, antennas and/or RIS 130 may be added, removed or suffer from an outage. The network node 110 may predict a change in the wireless communications network. The predication may be based on historical data and/or monitored movement of the terminals 120. The historical data may comprise one or more of a data related to historical movement data of terminals 120, frequency of outages in network equipment such as radio network nodes 115, antennas and/or RISs 130, and/or the frequency of terminals 120 being added and/or removed from the wireless communications network. The historical data may further comprise time stamps related to events such as the events mentioned above. Monitored movement may mean that the network node 110 monitors the movement, such as changes of location, for each terminal 120. The historical data and the monitored movement of the terminals 120 may be used in combination achieve a more accurate prediction.

Action 305. In order to prepare for the predicted change in the wireless communications network 100, the network node 110 estimates new communication parameters. In response to the predicted change in wireless communications network 100, the network node 110 estimates for each terminal 120, one or more second communication parameters. The one or more second communication parameters are to be used for the beam-based communication between the terminal 120 and the radio network node 115. In other words, one of the mechanisms to improve the performance of the wireless communications network 100 in embodiments herein, is to estimate communication parameters based on predicted changes and/or events. This allows quick reactions to such changes and/or events, resulting an improved performance. The one or more second communication parameters may comprise any one or more out of: One or more second parameters related to a second beam to be used for communication between the terminal 120 and the radio network node 115, one or more second parameters related to the RIS 130, e.g. the first RIS 131 or the second RIS 132, for reflecting radio signals related to the second beam, and one or more second parameters related to the radio network node 115, e.g. the first radio network node 116 or the second radio network node 117, associated to the second beam. The second beam may be a different beam than the first beam.

The second beam and the first beam may be associated to the same radio network node 115, e.g. the first radio network node 116. When associated to the same radio network node 115, the second beam and the first beam may be associated to the same antenna or different antennas out of the one or more antennas connected to the radio network node 115. Alternatively, the second beam and the first beam may be associated to different radio network nodes connected with antenna. E.g. the first beam may be associated to the first radio network node 116 and the second beam may be associated to the second radio network node 117. In other words, the first beam and the second beam may be associated to the same or different radio network nodes.

The communication path of the second beam may be different than the communication path of the first beam. The RIS 130 for reflecting the second beam and the first beam may be the same RIS 130, e.g. the first RIS 131, or the second beam and the first beam may be reflected by different RISs. E.g. the first beam may be reflected by the first RIS 131 and the second beam may be reflected by the second RIS 132. Alternatively, the second beam and first beam may be reflected by different reflective elements associated to the same RIS 130, e.g. the RIS 131. The one or more second parameters related to the second beam may indicate a second beam for UL transmissions, e.g. a second UL beam and/or a second beam for DL transmissions, e.g. a second DL beam. Further, the one or more second parameters related to the second beam may comprise parameters related to the direction of the second beam and/or transmission power of the second beam. The one or more second parameters related to the RIS 130 may comprise parameters related to the angle of reflection of the reflective element, the reflection status of the reflective element and/or beam width of the reflected beam, e.g. a radio signal or radio wave. The one or more second parameters related to the radio network node 115 may comprise parameters related to the direction of the second beam, the antenna out of the one or more antennas connected to the radio network node 115 associated to the second beam and/or transmission power of the second beam.

In some embodiments, the one or more second communication parameters further comprise any one or more out of: one or more second parameters related to an additional second beam, e.g. a different second beam or a fourth beam, to be used for communication between the terminal 120 and the radio network node 115, one or more second parameters related to the RIS 130 for reflecting radio signals related to the additional second beam, and one or more second parameters related to the radio network node 115 associated to the additional second beam. The additional second beam may be a different beam than the second beam and may e.g. be referred to as the fourth beam or the different second beam.

The additional second beam and the second beam may be associated to the same radio network node 115, e.g. the first radio network node 116 or the second radio network node 117. When associated to the same radio network node 115, the additional second beam and the second beam may be associated to the same antenna or different antennas out of the one or more antennas connected to the radio network node 115. Alternatively, the additional second beam and the second beam may be associated to different radio network nodes. E.g. the second beam may be associated to the first radio network node 116 and the additional second beam may be associated to the second radio network node 117. In other words, the second beam and the additional second beam may be associated to the same or different radio network nodes.

The communication path of the additional second beam may be different than the communication path of the second beam.

The RIS 130 for reflecting the additional second beam and the second beam may be the same RIS 130, e.g. the first RIS 131 or the second RIS 132, or the additional second beam and the second beam may be reflected by different RISs. E.g. the second beam may be reflected by the first RIS 131 and the additional second beam may be reflected by the second RIS 132. Alternatively, the additional second beam and second beam may be reflected by different reflective elements associated to the same RIS 130, e.g. the RIS 131 or the second RIS 132.

The one or more second parameters related to the additional second beam may indicate an additional second beam for UL transmissions, e.g. an additional second UL beam and/or an additional second beam for DL transmissions, e.g. an additional second DL beam. Further, the one or more second parameters related to the additional second beam may comprise parameters related to the direction of the additional second beam and/or transmission power of the additional second beam. The one or more second parameters related to the RIS 130 may comprise parameters related to the angle of reflection of the reflective element, reflection status of the reflective element and/or beam width of reflected beam, e.g. a radio signal or radio wave. The one or more second parameters related to the radio network node 115 may comprise parameters related to the direction of the additional second beam, the antenna out of the one or more antennas connected to the radio network node 115 associated to the additional second beam and/or transmission power of the additional second beam.

As mentioned above, the predicted change in the wireless communications network 100 may comprise any one or more out of: A change of location of at least one terminal 120, a change of the number of terminals 120 operating in the wireless communications network 100, a change of number of radio network nodes 115 operating in the wireless communications network 100, a change of the number of active antennas in the wireless communications network 100, and a change of number RISs 130 in the wireless communications network 100. In some embodiments, the network node 110 estimates the one or more first communication parameters based on the machine learning process.

Action 306. In some embodiments the network node 110 evaluates the predicted change in wireless communications network 100. The network node 110 evaluates the predicted change by monitoring one or more present parameters, which one or more present parameters comprises any one or more out of: a movement of each terminal 120, the number of terminals 120 operating in the wireless communications network 100, the number of RISs 130 operating in the wireless communications network 100 the number of active antennas in the wireless communications network 100, and the number of radio network nodes 115 operating in the wireless communications network 100. Evaluating the prediction allows the network node 110 to make informed decisions on whether or not the estimated one or more second communication parameters are accurate. In some embodiments, the network node 110 evaluates the predicted change in wireless communications network 100 based on the machine learning process.

Action 307. Based on the evaluation of the predicted change taking the one or more present parameters into account, the network node 110 updates the configuration of each terminal 120, radio network node 115 and RIS 130 according to the one or more second communication parameters. The configuration is updated in order to handle the beam-based communication. This enables the network node 110 handle the beam-based communication efficiently, resulting in an improved performance of the wireless communications network. This since by predicting changes in the wireless communications network 100, estimating new communications parameters based on the prediction, and based on the evaluation of the prediction, update the configuring the entities, such as terminals 120, RISs 130 and radio network nodes 115, with the new communication parameters. Updating the configuration of the radio network node 115 may comprise updating the configuration of the one or more antennas connected to the radio network node 115 according to the predicted one or more configuration parameters. Action 308. In some embodiments the network node 110 obtains feedback comprising measurement data related to the beam-based communication between each terminal 120 and radio network node 115. The measurement data may be based on measurements performed by one or more terminal 120 and/or one or more radio network nodes 115. The feedback may be obtained e.g. by receiving measurement reports from one or more terminal 120 and/or from one or more radio network nodes 115. The obtained feedback may further comprise data related to movement of terminals 120, operational status of RISs 130 and radio network nodes 115, operational status of the one or more antennas connected to the radio network nodes 115, and/or time stamps. The time stamps may be associated to the data comprised in the feedback. This enables the network node 110 to more accurately current and/future changes in the wireless communications network 100 and predict and/or estimate communication parameters, which improves the performance of the wireless communications network 100.

Action 309. In some embodiments the network node 110 updates the machine learning process based on the obtained feedback. By updating the machine learning process, the network node 110 may more efficiently handle the beam-based communication.

In the below examples, five embodiments of methods are described.

A first method, Method 1 comprises actions performed by the network node 110, to handle beam-based communication, the beam based communication satisfying a criteria, such as e.g. the criteria related to high data rate communications, high capacity communications and/or low latency communications.

A second method, Method 2 comprises actions performed by the network node 110, to handle beam-based communication, the beam-based communication satisfying a criterium, such as e.g. the criteria related to high reliability communications.

A third method, Method 3 comprises actions performed by the network node 110, to handle beam-based communication, the beam-based communication satisfying criteria, such as e.g. the criteria related to high reliability communications.

A fourth method, Method 4 comprises actions performed by the network node 110, to handle beam-based communication, the beam based communication satisfying a criteria, such as e.g. the criteria related to high reliability communications in addition to the criteria related to high data rate communications, high capacity communications and/or low latency communications.

A fifth method, Method 5 comprises actions performed by the network node 110, to handle beam-based communication, the beam based communication satisfying a criteria, such as e.g. the criteria related to high reliability communications in addition to the criteria related to high data rate communications, high capacity communications and/or low latency communications.

In all five methods, one or more base stations, such as e.g. the radio network node 115, may provide narrow beams for beam based communication to one or more terminals, such as e.g. the terminal 120. One or more RISs, such as e.g. the RIS 130 may be used to provide reflection of the narrow beams. Milli-meter wave radio waves may be used for the narrow beams.

The five methods follow the same four steps respectively:
Initial deployment.
Initial setting.
Initial adjustment.
Update of base station, antenna and RIS.

Actions S11-S14 are related to an example of Method 1 and will be described below. The criteria mentioned above may be related to e.g. ultra-high capacity, ultra-high data rates and/or ultra-low latency. The problem of ultra-high data rates and ultra-high capacity communication is how to handle a beam-based communication path that achieves high data rates and high capacity. It may be desirable to use a minimum number of beams, such as e.g. one beam, to reduce interference between terminals, base stations, and antennas.

### Action S11

A network node, such as e.g. the network node 110, may be used to efficiently determine the optimal number and location of base stations, such as e.g. radio network nodes 115, base station antenna, such as the one or more antennas connected to the radio network node 115, and RISs, such as e.g. RISs 130. The number and locations of base stations, base station antenna and RISs, may be determined based on the total numbers of terminals operating in a wireless communications network, each terminal having a related range, movement area, communication requirement etc. The communication requirement may be e.g. the criteria mentioned above.

The network node 110 may predict an increase and/or decrease in the number of terminals and the density of terminal in respect to their locations on the time axis, e.g. based on contents of production and production rates at factories, work at construction sites etc. This means that the prediction may provide the network node 110 with data on how the need for communication resources, such as e.g. beams, capacity and/or throughput, may vary over time. The prediction may be used when determining the number and location of base stations, base station antennas and RISs.

An Artificial Intelligence (AI), such as the machine learning process, may perform the actions described above. The AI may have been trained before determining the number and location of base stations, base station antennas and RISs. The AI may further continue to learn, enabling the AI to improve predictions and determinations.

### S12

The network node 110 predicts a configuration, such as the one or more first communication parameters, for each terminal to be used for the beam-based communication. The prediction may be performed when the number and location of terminals, base stations, base station antennas and RISs have been determined and/or predicted. The configuration may comprise, such as include, an optimal antenna, a beam, such as a first beam, whether a RIS is used to reflect the beam and the angle of reflection and/or the direction of the beam, such as the one or more first parameters related to the RIS for reflecting radio signals related to the first beam. The prediction may be performed by the AI.

Based on the prediction, the wireless communication system is operated, such as the network node 110 configures each terminal, RIS and base station with the predicted configuration.

This action is related to Actions 301 and 303 described above.

### S13

A terminal may switch to a new beam. The switch may be initiated by the terminal or the network node 110. The network node 110 may learn, such as obtain or receive information and/or an indication, about the beam switch. If the AI is used, and there has not been a change in the number and position of the terminals, the AI may use the information to learn for future predictions and estimations.

This action is related to Actions 301 and 303 described above.

### S14

During operation, there may be a change in the wireless communications network, such as e.g. one or more terminals may move, such change location, or the number of terminals may change. This may result in that the combination of base stations, antennas, beams, and RIS for each terminal so far will be changed. The network node 110 predicts the change of location of the one or more terminals and/or the change of the numbers of terminal. the network node 110 search for the optimal combination of base stations, antennas, beams, and RIS for each terminal. In other words, the network node 110 estimates one or more second communication parameters for each terminal. The network node 110 may monitor the wireless communications network 100 in order to evaluate the predicted changes. If the evaluation shows, such as indicates, that the predication is accurate, e.g. terminals have moved as expected, the network node 110 instructs the terminals to start communication according to the new optimal combination of base stations, antennas, beams, and RIS. In other words, the network node 110 configures each terminal, radio network node and RIS according to the one or more second communication parameters.

This reduces the time required to observe the antennas and beam received power of the robots/terminals for updates and to switch the beams, so that the optimal antennas and beams are always available. After the beam switch, such as after applying the new configuration, each terminal continues to monitor e.g. reference signals. If an optimal beam is found in the vicinity of the used beam, it may switch to that beam. The network node 110 may learn, such as obtain or receive information and/or an indication, about the beam switch. If the AI is used, and there has not been a change in the number and position of the terminals, the AI may use the information to learn for future predictions and estimations.

This action is related to Actions 304-307 described above.

Actions S21-S24 are related to an example of Method 2 and will be described below. The criteria mentioned above may be related to e.g. ultra-high reliability communication. The problem of ultra-high reliability communication is how to secure a stable beam-based communication path to prevent instantaneous communication breaks that may occur e.g. caused by the beam used for communication being blocked. Therefore, the priority may be to secure multiple communication paths, such as e.g. using more than one beam for the communication between a terminal a radio network node, rather than aiming high speed and high capacity.

The actions performed according to Method 2 is the same as Actions S11-S14 described above, with some differences. The differences are described in Actions S21-S24 below. According to Method 2, the network node 110 further takes into account that at least two beam-based communication paths for each terminal may be provided.

S21. Further to Action S11, the network node 110 will take into account that at least two beam-based communication paths for each terminal may be provided.

S22. Further to Action S12, the network node 110 will take into account that at least two beam-based communication paths for each terminal may be provided. This may mean that the network node 110 predicts the configuration, such as the one or more first communication parameters, for each terminal to be used for the beam-based communication. The configuration, such as the one or more first communication parameters, may here further comprise, such as include, an additional first optimal antenna, a beam, such as the additional first beam, whether a RIS is used to reflect the beam and the angle of reflection and/or the direction of the beam, such as the one or more first parameters related to the RIS for reflecting radio signals related to the additional first beam, where the RIS may the same RIS or a different RIS as in Action S11.

This action is related to Actions 301 and 303.

S23. Further to Action S13, the network node 110 will take into account that at least two beam-based communication paths for each terminal may be provided.

S24. Further to Action S14, the network node 110 will take into account that at least two beam-based communication paths for each terminal may be provided. This may mean that the network node 110 predicts the change of location of the one or more terminals and/or the change of the numbers of terminal. the network node 110 search for the optimal combination of base stations, antennas, beams, and RIS for each terminal. In other words, the network node 110 estimates one or more second communication parameters for each terminal. the optimal combination, such as the one or more second communication parameters, may here further comprise, such as include, an additional second optimal antenna, a beam, such as the additional second beam, whether a RIS is used to reflect the beam and the angle of reflection and/or the direction of the beam such as the one or more second parameters related to the RIS for reflecting radio signals related to the additional second beam, where the RIS may the same RIS or a different RIS as in Action S14. In some embodiments, only one communication path is affected the by the change in the wireless communications network 100, e.g. the beam used for one communication path is expected to be blocked, and in some embodiments more than one communication path is affected the by the change. The network node 110 may take this into account when estimating the one or more second communication parameters. In other words, the network node 110 only updates the configuration when the predicted change is predicted to affect a communication path, e.g. such that the one or more of the one or more criteria is no longer satisfied.

This action is related to Actions 304-307 described above.

Method 3 is an alternative method for when the criteria mentioned above may be related to e.g. ultra-high reliability communication. The actions performed according to Method 3 is the same as Actions S21-S24 described above, with some differences. According the Method 3, the network node 110 further divides the communication bandwidth into two sub-bands. The first sub-band is used for the best communication path for each terminal. The second sub-band is used for the second-best communication path.

This is related to Action 302 described above.

According the fourth method, Method 4, the actions performed are the same as Actions S11-S14 of Method 1, but in this example combined with the actions performed in Method 2 and/or Method 3 described above, with some further differences. According the Method 4, the network node 110 divides the communication bandwidth into at least two sub-bands. E.g. a first sub-band is allocated for communication according to one or more first criteria out of the one or more criteria described above, and a second sub-band is allocated for communication according one or more second criteria out of the criteria described above. The one or more first criteria may be different than the one or more second criteria. The first and second criteria may be any one or more of the criteria described above. Communication according the one or more first criteria may e.g. be communication related to Method 1, and communication according the one or more second criteria may e.g. be related to communication related to Method 2 and/or Method 3. The network node 110 may divide the communication bandwidth according to the communication volume of the communications related Method 1 and one or both of Method 2 and Method 3. Since each bandwidth is used optimally for each purpose, it is easy to control. In order to avoid loss due to the divided bandwidth, e.g. when communication fluctuations occur, it may be possible to reserve a certain amount of bandwidth respectively and then change, such as reallocate, the available bandwidth in the different sub-bands in a relatively short period of time. The AI may be used to perform the actions described above. The AI may learn, according to one or more communication criterias, type of communications and situation, and perform predictions and estimation for proactive and dynamic allocation of bandwidth.

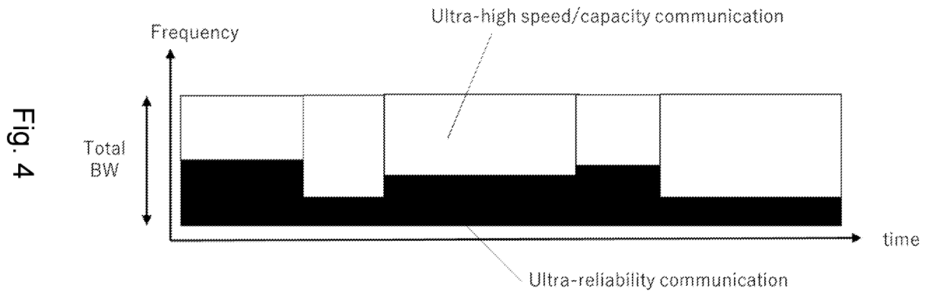

FIG. 4 shows an example of the bandwidth divided into two sub-bands. According to the example, the first sub-band is allocated for communication related to Method 1 and the second sub-band is allocated to communication related to Method 2 and/or Method 3.

This is related to Action 302 described above.

Method 5 is an alternative method to Method 4. According to Method 5, the communication bandwidth is not divided into sub-bands, but rather the same bandwidth is shared for communications related Method 1 and one or both of Method 2 and Method 3. Both communications are less optimal than if they were alone, since they have different requirements with different prioritized communication parameters. For example, scheduling may be used to separate communications related to Method 1 and Method 2/Method 3. That may mean that a certain group of slots/sub-frames is scheduled for ultra-high capacity, ultra-high data rates and/or ultra-low latency, and another group of slots/sub-frames is scheduled for ultra-high reliability communication. Some group may include both communications. The AI may be used to perform the actions described above. The AI will support the selection of the combination that minimizes the overall SINR degradation due to the addition of the second path for ultra-high reliability communications.

This is related to Action 302 described above.

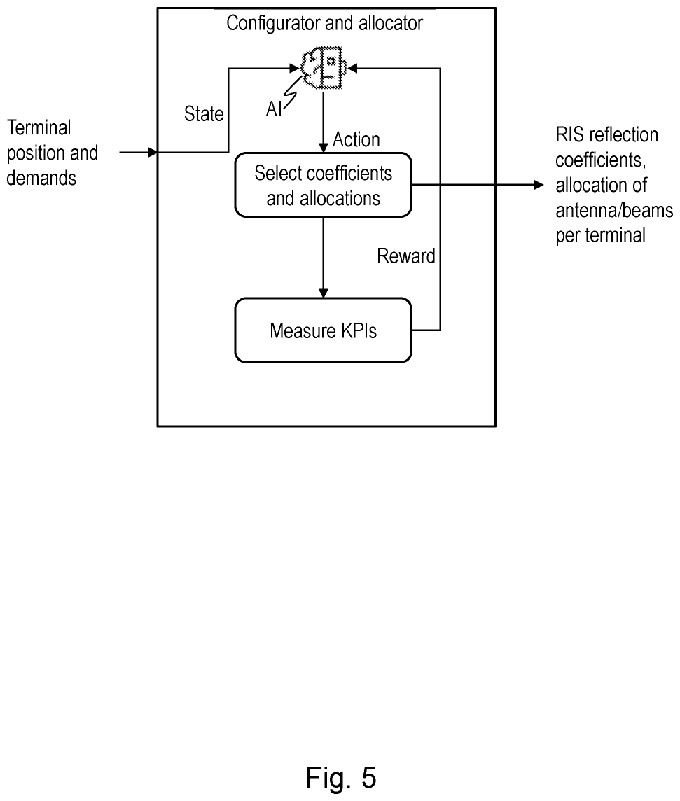

FIG. 5. shows a configurator and allocator component according to embodiments herein. The configurator and allocator component may comprise the AI, and may further be comprised in the network node 110. Any optimization algorithm may be used to find a configuration of RIS's and their positions, and allocation of antennas and beams to the UEs. Since update is dynamic, a reinforcement learning based agent, e.g. the AI, may be trained to configure parameters related to the RISs 130, such as reflection coefficients, radio network nodes 115, such as allocation of antennas and beams, and terminals 120. A naïve, feasible but not practical because of the need for huge training data, way of training the AI is by selecting the coefficients and allocations randomly and collecting rewards and/or penalties in terms of the measured KPIs and service continuity and/or disruptions. A more informative way of selecting the actions, essentially limiting the action space, may be through mathematical models and simulations, which needs to approximate the coverage and capacity provided by a reflection configuration and also to predict the positions of mobile UEs. The AI may be used to perform the actions according to the embodiments described above.

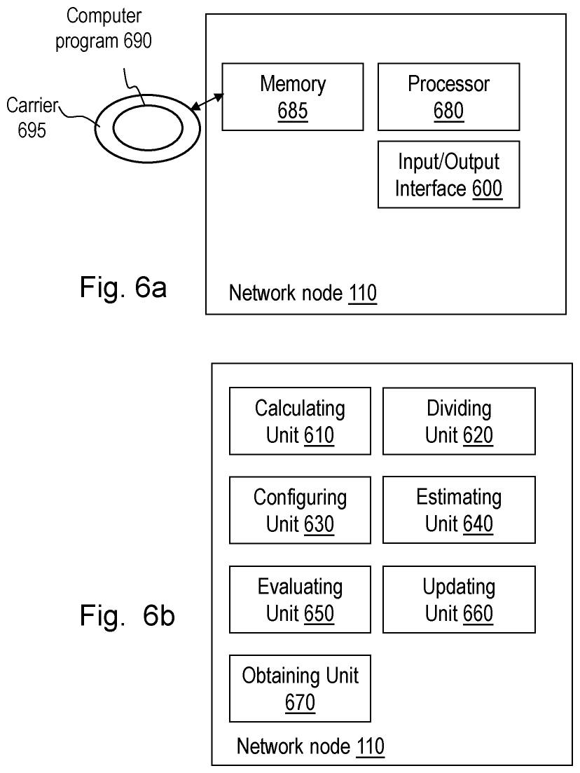

To perform the method actions above, the network node 110 is configured to handle beam-based communication between a wireless device 120 and a radio network node in a wireless communications network 100. The wireless communications network is adapted to comprise a RIS 130 configured to reflect radio signals between the wireless device 120 and the radio network node 115. The RIS 130 is adapted to be controlled by the network node 110. The network node 110 may comprise an arrangement depicted in FIGS. 6a and 6b.

The network node 110 may comprise an input and output interface 600 configured to communicate with radio network nodes such as the radio network nodes 115, wireless devices such as the wireless device 120, RISs such as the RIS 130, and other network nodes in the wireless communications network 100. The input and output interface 600 may comprise a wireless receiver (not shown) and a wireless transmitter (not shown).

The network node 110 is further be configured to, e.g. by means of a predicting unit 610 in the network node 110, predict for each wireless device 120, one or more first communication parameters adapted to be used for the beam-based communication between the wireless device 120 and the radio network node 115. The beam-based communication is adapted to satisfy one or more criteria.

The network node 110 may further be configured to, e.g. by means of the predicting unit 610 in the network node 110, predict the one or more first communication parameters based on the machine learning process.

The network node 110 may further be configured to, e.g. by means of the predicting unit 610 in the network node 110, predict the one or more first communication parameters based on the location of the wireless device.

The one or more criteria may be adapted to comprise any one or more out of: A criteria related to high data rate communications, a criterium related high capacity communications, a criterium related high reliability communications, and a criterium related low latency communications.

The one or more first communication parameters may be adapted to comprise any one or more out of: One or more first parameters adapted to be related to a first beam to be used for communication between the wireless device 120 and the radio network node 115, one or more first parameters adapted to be related to the RIS 130 to control the reflecting of radio signals related to the first beam, and one or more first parameters adapted to be related to the radio network node 115 associated to the first beam.

The one or more first communication parameters may further be adapted to comprise any one or more out of: one or more first parameters adapted to be related to an additional first beam to be used for communication between the wireless device 120 and the radio network node 115, which additional first beam is adapted to have a communication path that is different from the first beam, one or more first parameters adapted to be related to the RIS 130 to control the reflecting of radio signals related to the additional first beam, and one or more first parameters adapted to be related to the radio network node 115 associated to the additional first beam.

The network node 110 may further be configured to, e.g. by means of a dividing unit 620 in the network node 110, divide a communication bandwidth adapted to be used for the beam-based communication in the wireless communications network 100 into at least two sub-bands. The at least two sub-bands are adapted to be allocated based on the one or more criteria.

The network node 110 is further be configured to, e.g. by means of a configuring unit 630 in the network node 110, configure each wireless device 120, radio network node 115 and RIS 130 based on the predicted one or more first communication parameters.

The network node 110 is further be configured to, e.g. by means of an estimating unit 640 in the network node 110, in response to a predicted change in wireless communications network 100, estimate for each wireless device 120, one or more second communication parameters. The one or more second communication parameters are adapted to be used for the beam-based communication between the wireless device 120 and the radio network node 115.

The network node 110 may further be configured to, e.g. by means of the estimating unit 640 in the network node 110, estimate the one or more second communication parameters based on a machine learning process.

The one or more second communication parameters may be adapted to comprise any one or more out of: One or more second parameters adapted to be related to a second beam to be used for communication between the wireless device 120 and the radio network node 115, one or more second parameters adapted to be related to the RIS to control the reflecting of radio signals related to the second beam, and one or more second parameters adapted to be related to the radio network node 115 associated to the second beam.

The one or more second communication parameters may further be adapted to comprises any one or more out of: one or more second parameters adapted to be related to an additional second beam to be used for communication between the wireless device and the radio network node 115, which additional second beam is adapted to have a communication path that is different from the second beam, one or more second parameters adapted to be related to the RIS 130 to control the reflecting of radio signals related to the additional second beam, and one or more second parameters adapted to be related to the radio network node 115 associated to the additional second beam.

The predicted change in the wireless communications network 100 may be adapted to comprise any one or more out of: A change of location of at least one wireless device 120, and a change of the number of wireless devices 120 operating in the wireless communications network 100, a change of the number of RISs 130 operating in the wireless communications network 100, and a change of the number of radio network nodes 115 operating in the wireless communications network 100.

The network node 110 may further be configured to, e.g. by means of an evaluating unit 650 in the network node 110, evaluate the predicted change in wireless communications network 100 by monitoring the movement of each wireless device 120 and the number of wireless devices 120 operating in the wireless communications network 100.

The network node 110 is further be configured to, e.g. by means of an updating unit 660 in the network node 110, based on an evaluation of the predicted change in wireless communications network 100, update the configuration of each wireless device 120, radio network node 115 and RIS 130 according to the one or more second communication parameters. The configuration is performed in order to handle the beam-based communication.

The network node 110 may further be configured to, e.g. by means of the updating unit 660 in the network node 110, update the machine learning process based on the obtained feedback.

The network node 110 is further be configured to, e.g. by means of an obtaining unit 670 in the network node 110, obtain feedback adapted to comprise measurement data. The measurement data is adapted to be related to the beam-based communication between the wireless device 120 and the radio network node 115.

The embodiments herein may be implemented through a respective processor or one or more processors, such as the processor 680 of a processing circuitry in the network node 110 depicted in FIG. 6a, together with respective computer program code for performing the functions and actions of the embodiments herein. The program code mentioned above may also be provided as a computer program product, for instance in the form of a data carrier carrying computer program code for performing the embodiments herein when being loaded into the network node 110. One such carrier may be in the form of a CD ROM disc. It is however feasible with other data carriers such as a memory stick. The computer program code may furthermore be provided as pure program code on a server and downloaded to the network node 110.

The network node 110 may further comprise a memory 685 comprising one or more memory units. The memory 685 comprises instructions executable by the processor in network node 110. The memory 685 is arranged to be used to store e.g. one or more first and second communication parameters, predictions, estimations, evaluations, configurations and applications to perform the methods herein when being executed in the network node 110.

In some embodiments, a computer program 690 comprises instructions, which when executed by the respective at least one processor 680, cause the at least one processor 680 of the network node 110 to perform the actions above.

In some embodiments, a respective carrier 695 comprises the respective computer program 690, wherein the carrier 695 is one of an electronic signal, an optical signal, an electromagnetic signal, a magnetic signal, an electric signal, a radio signal, a microwave signal, or a computer-readable storage medium.

Those skilled in the art will appreciate that the units in the network node 110 described above may refer to a combination of analog and digital circuits, and/or one or more processors configured with software and/or firmware, e.g. stored in the network node 110, that when executed by the respective one or more processors such as the processors described above. One or more of these processors, as well as the other digital hardware, may be included in a single Application-Specific Integrated Circuitry (ASIC), or several processors and various digital hardware may be distributed among several separate components, whether individually packaged or assembled into a system-on-a-chip (SoC).

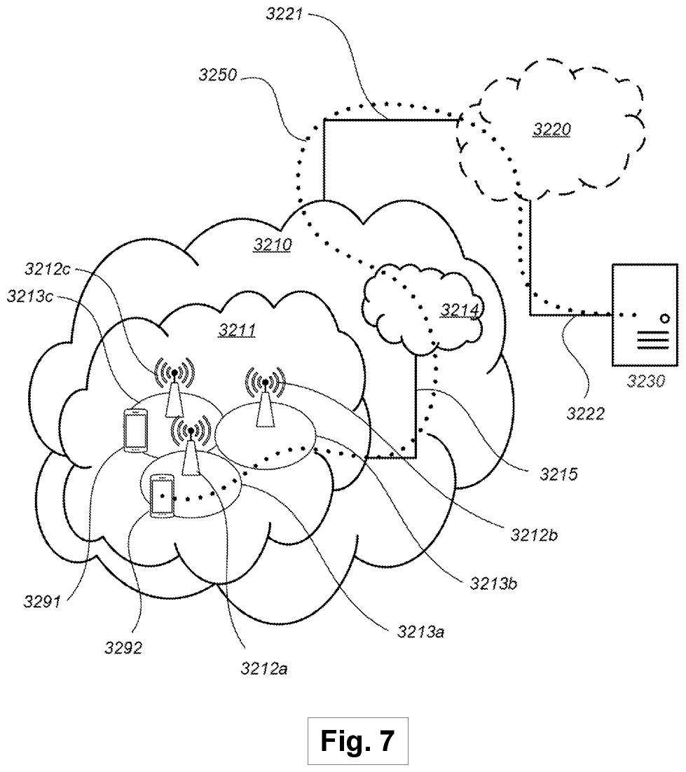

With reference to FIG. 7, in accordance with an embodiment, a communication system includes a telecommunication network 3210 such as the wireless communications network 100, e.g. an IoT network, or a WLAN, such as a 3GPP-type cellular network, which comprises an access network 3211, such as a radio access network, and a core network 3214. The access network 3211 comprises a plurality of base stations 3212a, 3212b, 3212c, such as the network node 110 and the radio network node 115, access nodes, AP STAs NBs, eNBs, gNBs or other types of wireless access points, each defining a corresponding coverage area 3213a, 3213b, 3213c. Each base station 3212a, 3212b, 3212c is connectable to the core network 3214 over a wired or wireless connection 3215. A first user equipment (UE) e.g. the terminal 120 such as a Non-AP STA 3291 located in coverage area 3213c is configured to wirelessly connect to, or be paged by, the corresponding base station 3212c. A second UE 3292 such as a Non-AP STA in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

The communication system of FIG. 7 as a whole enables connectivity between one of the connected UEs 3291, 3292 and the host computer 3230. The connectivity may be described as an over-the-top (OTT) connection 3250. The host computer 3230 and the connected UEs 3291, 3292 are configured to communicate data and/or signaling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE towards the host computer 3230.

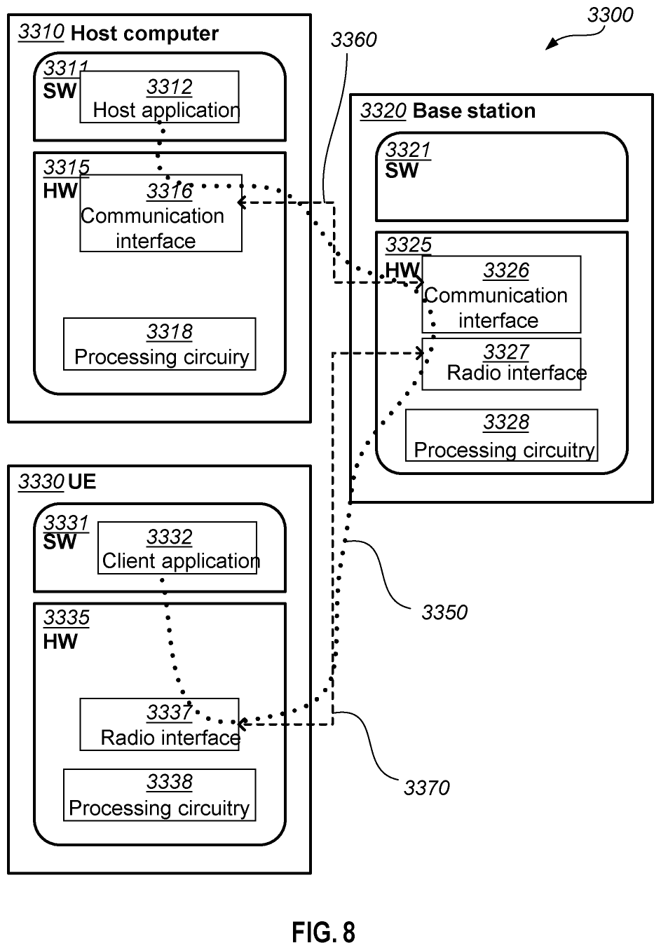

Example implementations, in accordance with an embodiment, of the UE, base station and host computer discussed in the preceding paragraphs will now be described with reference to FIG. 8. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown) served by the base station 3320. The communication interface 3326 may be configured to facilitate a connection 3360 to the host computer 3310. The connection 3360 may be direct or it may pass through a core network (not shown in FIG. 8) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to set up and maintain a wireless connection 3370 with a base station serving a coverage area in which the UE is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides.

It is noted that the host computer 3310, base station 3320 and UE 3330 illustrated in FIG. 8 may be identical to the host computer 3230, one of the base stations 3212a, 3212b, 3212c and one of the UEs 3291, 3292 of FIG. 7, respectively. This is to say, the inner workings of these entities may be as shown in FIG. 8 and independently, the surrounding network topology may be that of FIG. 7.

In FIG. 8, the OTT connection 3350 has been drawn abstractly to illustrate the communication between the host computer 3310 and the use equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing (e.g., on the basis of load balancing consideration or reconfiguration of the network).

The wireless connection 3370 between the UE 3330 and the base station 3320 is in accordance with the teachings of the embodiments described throughout this disclosure. One or more of the various embodiments improve the performance of OTT services provided to the UE 3330 using the OTT connection 3350, in which the wireless connection forms the last segment. More precisely, the teachings of these embodiments may improve the applicable RAN effect: data rate, latency, power consumption, and thereby provide benefits such as corresponding effect on the OTT service: e.g. reduced user waiting time, relaxed restriction on file size, better responsiveness, extended battery lifetime.

A measurement procedure may be provided for the purpose of monitoring data rate latency and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signaling facilitating the host computer's 3310 measurements of throughput, propagation times, latency and the like. The measurements may be implemented in that the software 3311, 3331 causes messages to be transmitted, in particular empty or ‘dummy’ messages, using the OTT connection 3350 while it monitors propagation times, errors etc.

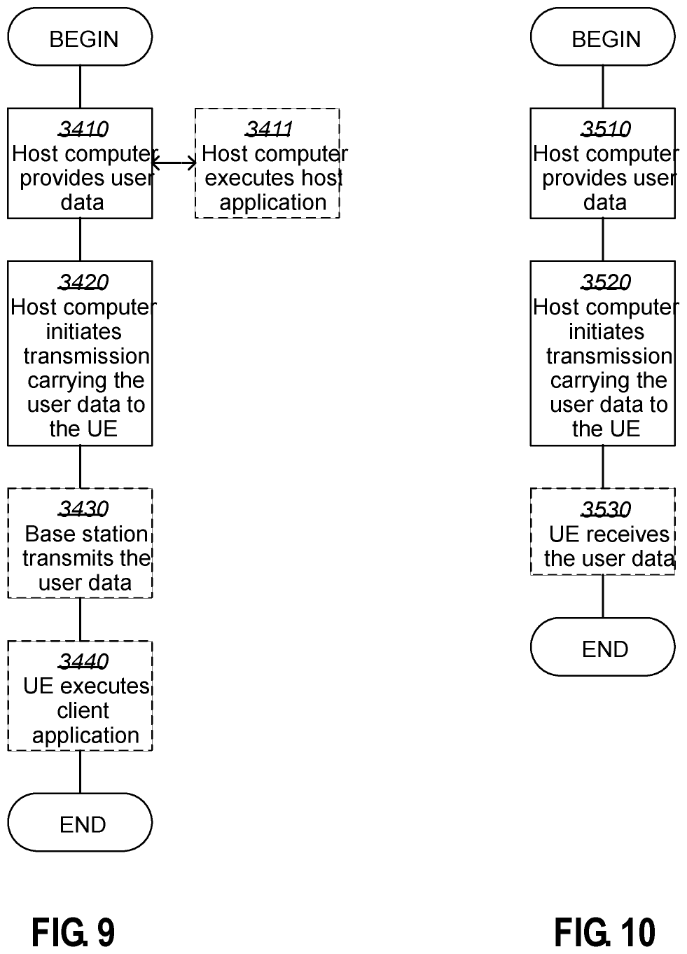

FIG. 9 is a flowchart illustrating a method implemented in a communication system, in accordance with one embodiment. The communication system includes a host computer, a base station such as the network node 112, and a UE such as the UE 120, which may be those described with reference to FIG. 7 and FIG. 8. For simplicity of the present disclosure, only drawing references to FIG. 9 will be included in this section. In a first action 3410 of the method, the host computer provides user data. In an optional subaction 3411 of the first action 3410, the host computer provides the user data by executing a host application. In a second action 3420, the host computer initiates a transmission carrying the user data to the UE. In an optional third action 3430, the base station transmits to the UE the user data which was carried in the transmission that the host computer initiated, in accordance with the teachings of the embodiments described throughout this disclosure. In an optional fourth action 3440, the UE executes a client application associated with the host application executed by the host computer.

FIG. 10 is a flowchart illustrating a method implemented in a communication system, in accordance with one embodiment. The communication system includes a host computer, a base station such as an AP STA, and a UE such as a Non-AP STA which may be those described with reference to FIG. 7 and FIG. 8. For simplicity of the present disclosure, only drawing references to FIG. 10 will be included in this section. In a first action 3510 of the method, the host computer provides user data. In an optional subaction (not shown) the host computer provides the user data by executing a host application. In a second action 3520, the host computer initiates a transmission carrying the user data to the UE. The transmission may pass via the base station, in accordance with the teachings of the embodiments described throughout this disclosure. In an optional third action 3530, the UE receives the user data carried in the transmission.

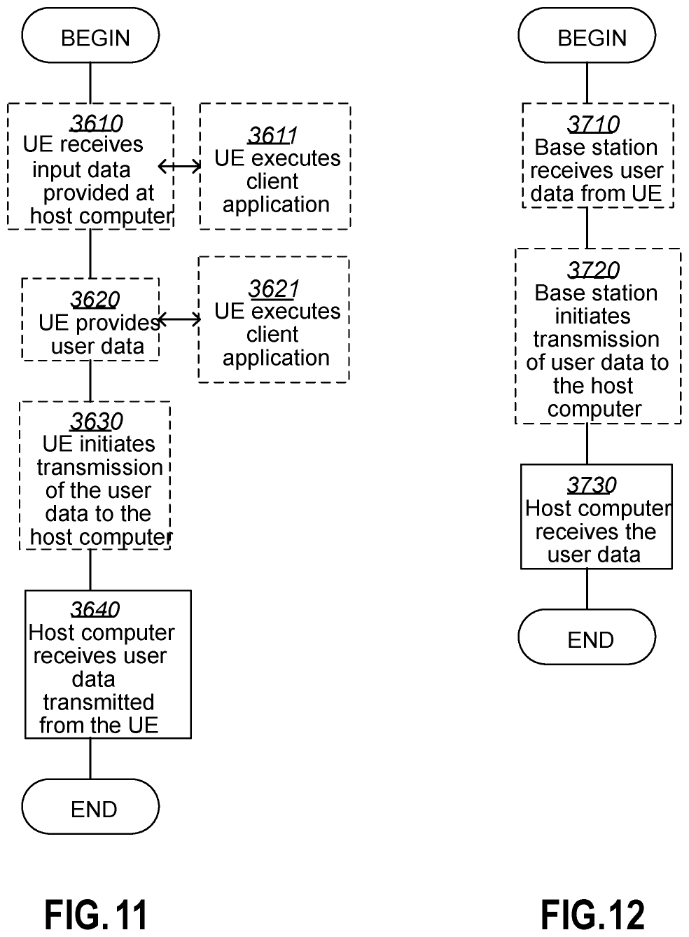

FIG. 11 is a flowchart illustrating a method implemented in a communication system, in accordance with one embodiment. The communication system includes a host computer, a base station such as an AP STA, and a UE such as a Non-AP STA which may be those described with reference to FIG. 7 and FIG. 8. For simplicity of the present disclosure, only drawing references to FIG. 11 will be included in this section. In an optional first action 3610 of the method, the UE receives input data provided by the host computer. Additionally or alternatively, in an optional second action 3620, the UE provides user data. In an optional subaction 3621 of the second action 3620, the UE provides the user data by executing a client application. In a further optional subaction 3611 of the first action 3610, the UE executes a client application which provides the user data in reaction to the received input data provided by the host computer. In providing the user data, the executed client application may further consider user input received from the user. Regardless of the specific manner in which the user data was provided, the UE initiates, in an optional third subaction 3630, transmission of the user data to the host computer. In a fourth action 3640 of the method, the host computer receives the user data transmitted from the UE, in accordance with the teachings of the embodiments described throughout this disclosure.

FIG. 12 is a flowchart illustrating a method implemented in a communication system, in accordance with one embodiment. The communication system includes a host computer, a base station such as an AP STA, and a UE such as a Non-AP STA which may be those described with reference to FIG. 7 and FIG. 8. For simplicity of the present disclosure, only drawing references to FIG. 12 will be included in this section. In an optional first action 3710 of the method, in accordance with the teachings of the embodiments described throughout this disclosure, the base station receives user data from the UE. In an optional second action 3720, the base station initiates transmission of the received user data to the host computer. In a third action 3730, the host computer receives the user data carried in the transmission initiated by the base station.

When using the word “comprise” or “comprising” it shall be interpreted as non-limiting, i.e. meaning “consist at least of”.

The embodiments herein are not limited to the above described preferred embodiments. Various alternatives, modifications and equivalents may be used.

It will be appreciated that the foregoing description and the accompanying drawings represent non-limiting examples of the methods and apparatus taught herein. As such, the apparatus and techniques taught herein are not limited by the foregoing description and accompanying drawings. Instead, the embodiments herein are limited only by the following claims and their legal equivalents.

1. A method performed by a network node for handling beam-based communication between a terminal and a radio network node in a wireless communications network, the wireless communication network comprising a Reconfigurable Intelligent Surface, RIS, for reflecting radio signals between the terminal and the radio network node, which RIS is controlled by the network node, the method comprising:
predicting for each terminal, one or more first communication parameters to be used for the beam-based communication between the terminal and the radio network node, which beam-based communication satisfies one or more criteria;
configuring each terminal, radio network node and RIS based on the predicted one or more first communication parameters;
in response to a predicted change in wireless communications network, estimating for each terminal, one or more second communication parameters to be used for the beam-based communication between the terminal and the radio network node; and
based on an evaluation of the predicted change taking one or more present parameters into account, updating the configuration of each terminal, radio network node and RIS according to the one or more second communication parameters in order to handle the beam-based communication.

2. The method according to claim 1, wherein predicting the one or more first communication parameters and estimating the one or more second communication parameters is based on a machine learning process.

3. The method according to claim 2, further comprising:
obtaining feedback comprising measurement data related to the beam-based communication between the terminal and the radio network node; and
updating the machine learning process based on the obtained feedback.

4. The method according to claim 1, wherein the one or more criteria comprises any one or more out of:
a criterium related to high data rate communications;
a criterium related high capacity communications;
a criterium related high reliability communications; and
a criterium related low latency communications.

5. The method according to claim 1, further comprising evaluating the predicted change in the wireless communications network by monitoring the one or more present parameters, which one or more present parameters comprises any one or more out of:
the movement of each terminal;
the number of terminals operating in the wireless communications network;
the number of RISs operating in the wireless communications network; and
the number of radio network nodes operating in the wireless communications network.

6. The method according to 5 claim 1, further comprising:
dividing a communication bandwidth used for the beam-based communication in the wireless communications network into at least two sub-bands, wherein the at least two sub-bands are allocated based on the one or more criteria.

7. The method according to claim 1, wherein the one or more first communication parameters comprises any one or more out of:
one or more first parameters related to a first beam to be used for communication between the terminal and the radio network node; and
one or more first parameters related to the RIS for controlling the reflecting of radio signals related to the first beam; and
one or more first parameters related to the radio network node associated to the first beam; and
wherein the one or more second communication parameters comprises any one or more out of:
one or more second parameters related to a second beam to be used for communication between the terminal and the radio network node;
one or more second parameters related to the RIS for controlling the reflecting of radio signals related to the second beam; and
one or more second parameters related to the radio network node associated to the second beam.

8. The method according to claim 7, wherein the one or more first communication parameters further comprises any one or more out of:
one or more first parameters related to an additional first beam to be used for communication between the terminal and the radio network node, which additional first beam has a communication path that is different from the first beam;
one or more first parameters related to the RIS for controlling the of reflecting radio signals related to the additional first beam; and
one or more first parameters related to the radio network node associated to the additional first beam;
and wherein the one or more second communication parameters further comprises any one or more out of:
one or more second parameters related to an additional second beam to be used for communication between the terminal and the radio network node;
one or more second parameters related to the RIS for controlling the reflecting of radio signals related to the additional second beam; and
one or more second parameters related to the radio network node associated to the additional second beam.

9. The method according to claim 1, wherein predicting the one or more first communication parameters for a terminal is based on the location of the terminal.

10. The method according to claim 1, wherein the predicted change in the wireless communications network comprises any one or more out of:
a change of location of at least one terminal;
a change of the number of terminals operating in the wireless communications network;
a change of the number of RISs operating in the wireless communications network; and
a change of the number of radio network nodes operating in the wireless communications network.

11. (canceled)

12. (canceled)

13. A network node configured to handle beam-based communication between a terminal and a radio network node in a wireless communications network, the wireless communication network comprising a Reconfigurable Intelligent Surface, RIS, configured to reflect radio signals between the terminal and the radio network node, which RIS is adapted to be controlled by the network node, the network node is further configured to:
predict for each terminal, one or more first communication parameters adapted to be used for the beam-based communication between the terminal and the radio network node, which beam-based communication is adapted to satisfy one or more criteria;
configure each terminal, radio network node and RIS based on the predicted one or more first communication parameters;
in response to a predicted change in wireless communications network, estimate for each terminal, one or more second communication parameters adapted to be used for the beam-based communication between the terminal and the radio network node; and
based on an evaluation of the predicted change taking one or more present parameters into account, update the configuration of each terminal, radio network node and RIS according to the one or more second communication parameters in order to handle the beam-based communication.

14. The network node according to claim 13, further configured to predict the one or more first communication parameters and estimate the one or more second communication parameters based on a machine learning process.

15. The network node according to claim 14, further being configured to:
obtain feedback adapted to comprise measurement data adapted to be related to the beam-based communication between the terminal and the radio network node; and
update the machine learning process based on the obtained feedback.

16. The network node according to claim 13,
wherein the one or more criteria comprise any one or more out of:
a criterium related to high data rate communications;
a criterium related high capacity communications;
a criterium related high reliability communications; and
a criterium related low latency communications.

17. The network node according to claim 13, further being configured to:
evaluate the predicted change in wireless communications network by monitoring the one or more present parameters, which one or more present parameters is adapted to comprise any one or more out of:
the movement of each terminal;
the number of terminals operating in the wireless communications network;
the number of RISs operating in the wireless communications network; and
the number of radio network nodes operating in the wireless communications network.

18. The network node according to claim 13, further being configured to:
divide a communication bandwidth adapted to be used for the beam-based communication in the wireless communications network into at least two sub-bands, wherein the at least two sub-bands are adapted to be allocated based on the one or more criteria.

19. The network node according to claim 13, wherein the one or more first communication parameters comprise any one or more out of:
one or more first parameters adapted to be related to a first beam to be used for communication between the terminal and the radio network node;
one or more first parameters adapted to be related to the RIS to control the reflecting of radio signals related to the first beam; and
one or more first parameters adapted to be related to the radio network node associated to the first beam;
and wherein the one or more second communication parameters are adapted to comprise any one or more out of:
one or more second parameters adapted to be related to a second beam to be used for communication between the terminal and the radio network node;
one or more second parameters adapted to be related to the RIS to control the reflecting of radio signals related to the second beam; and
one or more second parameters adapted to be related to the radio network node associated to the second beam.

20. The network node according to claim 19, wherein the one or more first communication parameters are further adapted to comprise any one or more out of:
one or more first parameters adapted to be related to an additional first beam to be used for communication between the terminal and the radio network node, which additional first beam is adapted to have a communication path that is different from the first beam; and
one or more first parameters adapted to be related to the RIS to control the reflecting of radio signals related to the additional first beam; and
one or more first parameters adapted to be related to the radio network node associated to the additional first beam;
and wherein the one or more second communication parameters are further adapted to comprise any one or more out of:
one or more second parameters adapted to be related to an additional second beam to be used for communication between the terminal and the radio network node, which additional second beam is adapted to have a communication path that is different from the second beam;
one or more second parameters adapted to be related to the RIS to control the reflecting of radio signals related to the additional second beam; and
one or more second parameters adapted to be related to the radio network node associated to the additional second beam.

21. The network node according to claim 13, further being configured to predict the one or more first communication parameters based on the location of the terminal.

22. The network node according to claim 13, wherein the predicted change in the wireless communications network is adapted to comprise any one or more out of:
a change of location of at least one terminal; and
a change of the number of terminals operating in the wireless communications network;
a change of the number of RISs operating in the wireless communications network; and
a change of the number of radio network nodes operating in the wireless communications network.
